(19) United States
(12) Patent Application Publication
(10) Pub. No.: US 2026/0048608 A1
(43) Pub. Date: Feb. 19, 2026

(54) OPTICAL SECURITY ELEMENT

(71) Applicant: VIAVI SOLUTIONS INC., Chandler, AZ (US)

(72) Inventors: Vladimir P. RAKSHA, Santa Rosa, CA (US); Cornelis Jan Delst, Fairfax, CA (US)

(73) Assignee: VIAVI SOLUTIONS INC., Chandler, AZ (US)

(21) Appl. No.: 19/232,496

(22) Filed: Jun. 9, 2025

Related U.S. Application Data
(63) Continuation of application No. 18/595,021, filed on Mar. 4, 2024, now Pat. No. 12,344,024.
Application No. 18/595,021 is a division of application No. 17/839,013, filed on Jun. 13, 2022, now Pat. No. 11,945,255.
(60) Provisional application No. 63/210,365, filed on Jun. 14, 2021.

(51) Int. Cl. B42D 25/369; B42D 25/40

(52) U.S. Cl. CPC B42D 25/369; B42D 25/40

(57) ABSTRACT

An assembly including a first magnet; a substrate positioned above the first magnet, and having a surface for receiving a composition including a plurality of magnetizable platelets; and a second magnet, positioned above the substrate is disclosed. The assembly can be used in a method of making an optical security element. The optical security element and the method of making the optical security element are also disclosed.

### PRIORITY

This application is a Continuation of commonly assigned and co-pending U.S. patent application Ser. No. 18/595,021, filed Mar. 4, 2024, which is a divisional of U.S. patent application Ser. No. 17/839,013, filed Jun. 13, 2022, now U.S. Pat. No. 11,945,255, issued Apr. 2, 2024 which claims the benefit of U.S. Provisional Patent Application Ser. No. 63/210,365 filed on Jun. 14, 2021. The disclosures of all of the above applications are incorporated herein by reference in their entireties for all purposes.

### FIELD OF THE INVENTION

The present disclosure generally relates to an assembly including a first magnet; a substrate positioned above the first magnet, and having a surface for receiving a composition including a plurality of magnetizable platelets; and a second magnet, positioned above the substrate. The assembly can be used in a method of making an optical security element. The optical security element and the method of making the optical security element are also disclosed.

### BACKGROUND OF THE INVENTION

The current technology for the production of articles with security elements, such as banknotes, employs a single cylinder with embedded magnets. The embedded magnets align magnetic particles in an ink composition. In particular, a substrate with the ink composition is moved over the single cylinder. The embedded magnets produce a magnetic field that protrudes from one magnet toward another and mostly along a plane of the substrate. The magnetic particles in the ink composition are therefore subjected to this magnetic field, and create a singular optical effect.

There are two main methods for producing optical security elements: continuous and discrete. In a continuous method, platelets are oriented along a X coordinate, in a Cartesian coordinate system, of a continuously moving substrate with statically mounted magnetic assemblies. In a discrete method, platelets are oriented along the X and Y coordinates, of a continuously moving substrate with magnetic assemblies moving in the direction of the substrate at the same speed. The number of optical effects produced by the discrete method is much larger than by the continuous method.

What is needed is a way to produce articles with security elements with varying and/or different optical effects. The production of these articles should be capable of being generated in an efficient (time and cost) assembly system.

### BRIEF DESCRIPTION OF THE DRAWINGS

Features of the present disclosure are illustrated by way of example and not limited in the following figure(s), in which like numerals indicate like elements, in which:

FIG. 1 illustrates an assembly including a first magnet; a substrate positioned above the first magnet; a composition on a surface of the substrate and including a plurality of magnetizable platelets; and a second magnet, positioned above the substrate, according to an aspect of the invention;

FIG. 2 is a cross-section of an assembly according to another aspect of the invention;

FIG. 3 is a cross-section illustrating a first cylinder including a plurality of magnets, a second cylinder with a plurality of magnets, and a light source;

FIG. 4 illustrates an assembly including a second cylinder including a second magnet, a light source, and at least one mirror; and a first cylinder including a first magnet;

FIG. 5A is a top view illustrating positioning of a first magnet and a second magnet relative to a substrate;

FIGS. 5B and 5C illustrate a magnetic field produced by the first magnet and the second magnet of FIG. 5A;

FIG. 5D shows an image generated by the magnetic field in FIGS. 5B and 5C, and how the image changes upon tilting of the substrate;

FIG. 6A is a top view illustrating positioning of a first magnet and a second magnet relative to a substrate;

FIG. 6B shows an image generated by the magnetic field in FIG. 6A, and how the image changes upon tilting of the substrate;

FIG. 7A illustrates a positioning of a first magnet and a second magnet relative to a substrate;

FIG. 7B shows an image generated by the magnetic field in FIG. 7A, and how the image changes upon tilting of the substrate;

FIG. 8A is a cross-section illustrating a positioning of a first magnet and a second magnet relative to a substrate;

FIG. 8B shows an image generated by a magnetic field from the magnets in FIG. 8A, and how the image changes upon tilting of the substrate;

FIG. 8C illustrates how the image in FIG. 8B at a normal observation angle can change when viewed with two separate light sources;

FIG. 9A is a cross-section illustrating a positioning of a first magnet and a third magnet, and a second magnet relative to a substrate;

FIG. 9B shows an image generated by the magnetic field in FIG. 9A, and how the image changes upon tilting of the substrate;

FIG. 9C illustrates how the image from FIG. 9B changes with an alteration in a distance of a magnet to the substrate, and how the image changes upon tilting of the substrate;

FIG. 10A is a cross-section illustrating a positioning of a first magnet and a third magnet, and a second magnet relative to a substrate and a central axis;

FIG. 10B shows an image generated by a magnetic field of the magnets in FIG. 10A, and how the image changes upon tilting of the substrate;

FIG. 11 illustrates how the image from FIG. 9B changes with an alteration in a distance of a magnet to the substrate and a distance between a first magnet and a second magnet, and how the image changes upon tilting of the substrate;

FIG. 12A illustrates a first magnet and a second magnet relative to a substrate and a central axis, the magnetic field generated by rotation of a first magnet;

FIG. 12B is a cross-section of FIG. 12A illustrating multiple positions of the first magnet as it rotates about the central axis;

FIG. 12C is an enlarged view of FIG. 12B and illustrates positioning of magnetizable platelets within the magnetic field;

FIG. 12D is a topographical view of the image created by FIG. 12C with a light source; and

FIG. 12E is an image created by the assembly in FIG. 12A at a normal observation (left image) and how the image changes upon tilting of the substrate.

### SUMMARY OF THE INVENTION

In an aspect, there is disclosed an assembly including a first magnet; a substrate positioned above the first magnet, and having a surface for receiving a composition including a plurality of magnetizable platelets; and a second magnet, positioned above the substrate.

In another aspect, there is disclosed a method of producing an optical security element, can include moving a substrate, in a feed direction, between a first cylinder including a first magnet and a second cylinder including a second magnet; and rotating the first cylinder and the second cylinder at a same speed as the substrate; wherein a composition including a plurality of magnetizable platelets is present on a surface of the substrate.

Additional features and advantages of various embodiments will be set forth, in part, in the description that follows, and will, in part, be apparent from the description, or can be learned by the practice of various embodiments. The objectives and other advantages of various embodiments will be realized and attained by means of the elements and combinations particularly pointed out in the description herein.

### DETAILED DESCRIPTION OF THE INVENTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, the elements depicted in the accompanying figures may include additional components and some of the components described in those figures may be removed and/or modified without departing from scopes of the present disclosure. Further, the elements depicted in the figures may not be drawn to scale and thus, the elements may have sizes and/or configurations that differ from those shown in the figures.

It is to be understood that both the foregoing general description and the following detailed description are exemplary and explanatory only, and are intended to provide an explanation of various embodiments of the present teachings. In its broad and varied embodiments, disclosed herein are articles, such as banknotes with security elements; assemblies for use in a method of making the articles; and methods of making and using the articles and/or assemblies.

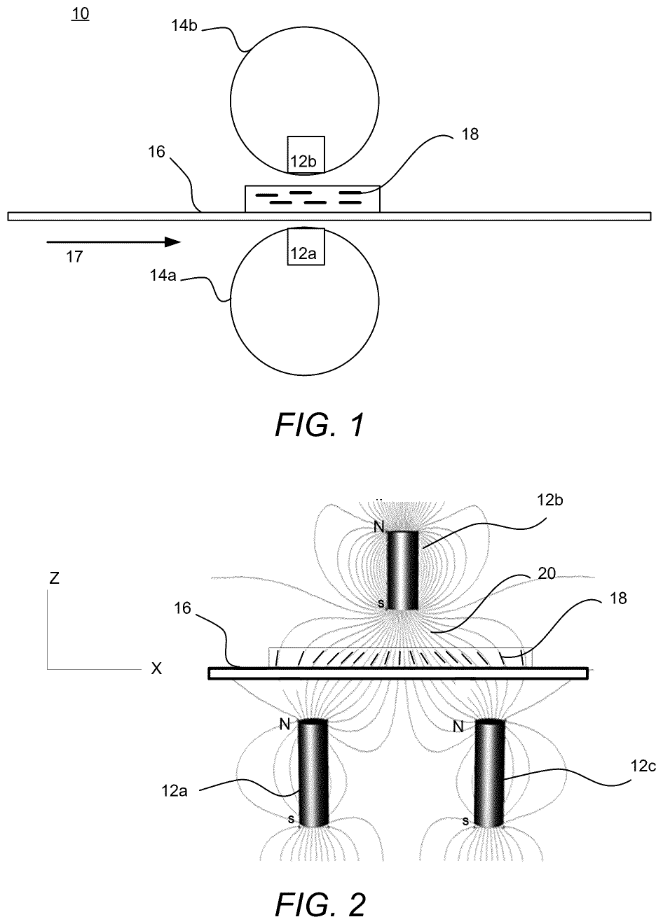

The present disclosure describes an assembly 10 including a first magnet 12a; a substrate 16, positioned above the first magnet 12a, and having a surface for receiving a composition including a plurality of magnetizable platelets 18; and a second magnet 12b, positioned above the substrate 16, as shown in FIG. 1. As discussed in more detail herein, the substrate 16 can move between two cylinders 14a, 14b, for example, a first cylinder 14a including the first magnet 12a and a second cylinder 14b including the second magnet 12b. The substrate 16 can move, in a feed direction 17, at the same or substantially the same speed as the rotation of the first and second cylinders 14a, 14b. The first magnet 12a is registered with respect to the first cylinder 14a, and the second magnet 12b is registered with respect to the second cylinder 14b. The substrate 16 can move through a magnetic field 20 generated by the first magnet 12a and the second magnet 12b to align the plurality of magnetizable platelets 18.

The substrate 16 can be any material capable of receiving a composition including a plurality of magnetizable platelets 18. Non-limiting examples of the substrate include paper, cardboard, plastic, etc. The substrate 16 can have a surface for receiving the composition.

The plurality of magnetizable platelets 18 can be dispersed in a binder. The plurality of magnetizable platelets 18 can be present in the composition in an amount sufficient to allow movement, such as alignment or orientation, of the plurality of magnetizable platelets 18 within the binder. The composition can include additional additives. The composition can be an ink, a pain, or a varnish.

The plurality of magnetizable platelets 18 can be any platelets including a magnetic material that can align and/or orient in a magnetic field 20. Non-limiting examples of magnetizable platelets 18 include NOVAMET™ (available from Novamet Specialty Products Corporation) magnetically soft nickel or stainless-steel platelets produced by the ball-mill technique; platelets of magnetizable material produced by vacuum deposition technique; and magnetizable platelets that are monochromatic or color-shifting thin-film interference security pigments containing a magnetizable material in their structure.

The magnetic field 20 generated by the first magnet 12a, the second magnet 12b, and the third magnet 12c goes up from XY to Z direction, as illustrated in FIG. 2. A composition including a plurality of magnetizable platelets 18 is present on a surface of a substrate 16. The plurality of magnetizable platelets 18 can be aligned in the magnetic field 20, such as in the Z direction. In this manner, a variety of optical effects can be achieved that is not possible with a single cylinder/magnet and its associated magnetic field.

The assembly 10 can include two or more magnets 12, such as a first magnet 12a, a second magnet 12b, a third magnet 12c. The assembly can include a plurality of magnets in which at least one magnet 12a is positioned below a substrate 16 and at least one magnet 12b is positioned above a substrate 16. As shown in FIG. 1, a first magnet 12a can be incorporated or embedded into a first cylinder 14a and a second magnet 12b can be incorporated or embedded into a second cylinder 14b.

The assembly can include a first cylinder 14a and a second cylinder 14b positioned with the substrate between them. The first cylinder 14a and the second cylinder 14b can be aligned together, for example, with the second cylinder 14b directly across a substrate 16 from the first cylinder.

The first cylinder 14a and the second cylinder 14b can rotate around an axis orthogonal to a feed direction 17. The first cylinder 14a and the second cylinder 14b can rotate at a same speed or a different speed. The first cylinder 14a and the second cylinder 14b can rotate at a same speed as a substrate 16 moving in a feed direction 17.

The first cylinder 14a and the second cylinder 14b can rotate in a same or an opposite direction. The first cylinder 14a can rotate in a first direction and the second cylinder 14b can rotate in a second direction, which is opposite from the first direction. In another aspect, the first cylinder 14a and the second cylinder 14b can rotate in a same direction.

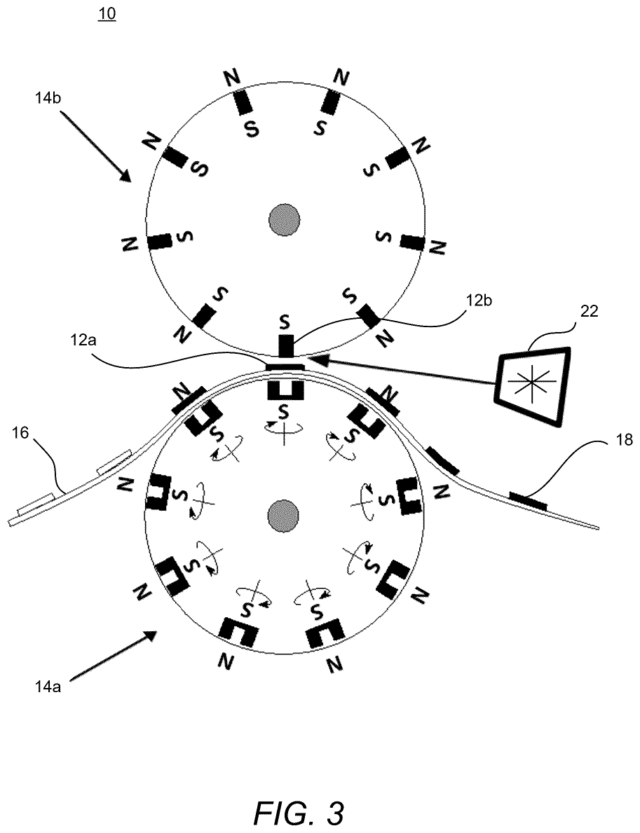

FIG. 3 illustrates an exemplary assembly 10 including a first cylinder 14a and second cylinder 14b. Each cylinder 14a, 14b can include one or more magnets, such as a first magnet 12a and a second magnet 12b. In an aspect, the one or more magnets, such as a plurality of magnets 12, can be evenly spaced around a circumference of each cylinder 14a, 14b. The one or more magnets 12a, 12b can be embedded into each cylinder 14a, 14b. In an aspect, the first magnet 12a can be a plurality of magnets embedded into a first cylinder 14a. In another aspect, the second magnet 12b can be a plurality of magnets embedded into a second cylinder 14b.

In an aspect, a magnet, such as the first magnet 12a of the first cylinder 14a, can face another magnet, such as the second magnet 12b of the second cylinder 14b. In an aspect, a first magnet 12a in a first cylinder 14a can be in register with a second magnet 12b in a second cylinder 14b.

The assembly 10 can also include a light source 22. The light source 22, such as a laser or a light emitting diode, can emit energy, for example, light in a blue wavelength or an ultraviolet wavelength. The energy can be focused towards a gap between the first cylinder 14a and the second cylinder 14b. In this manner, the light source 22 can cure a composition, present on a surface of the substrate, and including the plurality of magnetizable platelets 18. For example, the plurality of magnetizable platelets 18, after alignment in a magnetic field 20, can be fixed in the aligned and/or oriented state. The light source 22 can be a laser or a blue LED. The assembly 10 can also include a lens, such as a cylindrical lens. In an aspect, the light source 22, such as a diffracted light source, can refract through the lens to become a collimated light beam.

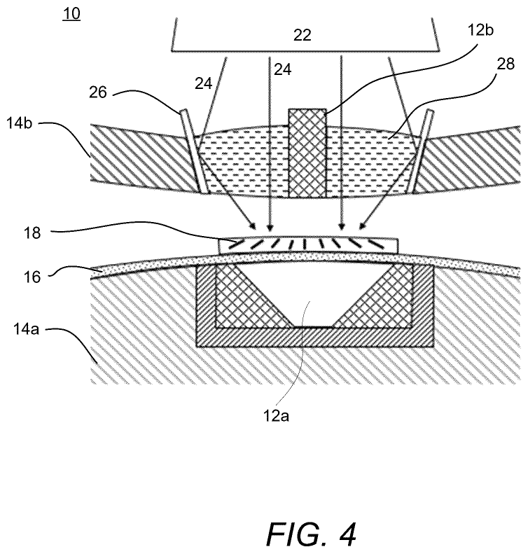

In another aspect, as shown in FIG. 4, an assembly 10 can include a light source 22, such as a UV lamp, located inside a second cylinder 14b. The first cylinder 14a can be solid, and can include a first magnet 12a that is funnel-shaped. The first cylinder 14a and the second cylinder 14b can rotate in a same direction. The second cylinder 14b can be hollow to include a second magnet 12b, which is cylindrical, and can be positioned within a lens 28, such as a quartz lens. The lens 28 can be surrounded by a metallic mirror 26. The metallic mirror 26 can be a singular cylindrical mirror with a hollow for receiving the lens 28. In another aspect, the metallic mirror, can be one or more metallic mirrors positioned around a lens 28. The light source 22 can emit light beams 24 and can illuminate the lens 28. The light beams 24 can arrive to the composition at a normal angle through the lens 28, while other light beams 24 reflect from the mirror 26.

The magnets 12a, 12b can be permanent magnets. In an aspect, the first magnet 12a and the second magnet 12b can be positioned so that a pole of the second magnet 12b faces a same pole of the first magnet 12a. In another aspect, a pole of the first magnet 12a can be positioned to face an opposite pole of the second magnet 12b.

A plane of the first magnet 12a can be parallel to a plane of the second magnet 12b. In an aspect, a plane of the first magnet 12a is at an angle greater than 0° to a plane of the second magnet 12b. The angle can be between 0° and 180°, for example between 5° and 170°, and as a further example, between 10° and 160°. In an aspect, the angle is about 15°.

The assembly 10 can include a second magnet 12b that is statically positioned along a central axis 28. A first magnet 12a can revolve around the central axis 28. In an aspect, the assembly 10 can include a first magnet 12a and a third magnet 12c that can revolve around the central axis 28, and can be positioned beneath a surface of the substrate 16 by a first distance 30. The second magnet 12b can be positioned above a substrate 16 by a second distance 32.

The assembly can be used to produce an article, such as an optical security element. A method of producing an optical security element, can comprise moving a substrate 16, in a feed direction 17, between a first cylinder 14a including a first magnet 12a and a second cylinder 14b including a second magnet 12b; and rotating the first cylinder 14a and the second cylinder 14b at a same speed as the substrate 16; wherein a composition including a plurality of magnetizable platelets 18 is present on a surface of the substrate 16. As the substrate 16 moves in the first direction between the first cylinder 14a and the second cylinder 14b, the magnetizable platelets 18 in the composition can be oriented in the magnetic field 20 generated by the first magnet 12a in the first cylinder 14a and the second magnet 12b in the second cylinder 14b. The oriented magnetizable platelets can be cured via a light source. The cured composition can exhibit an image, such as a symbol, a numeral, a shape, and etc. When the substrate 16 with the cured composition is tilted and/or the viewing angle is changed, the image can morph or deform and/or a portion of the image can become lighter or darker relative to another portion of the image.

### Example 1

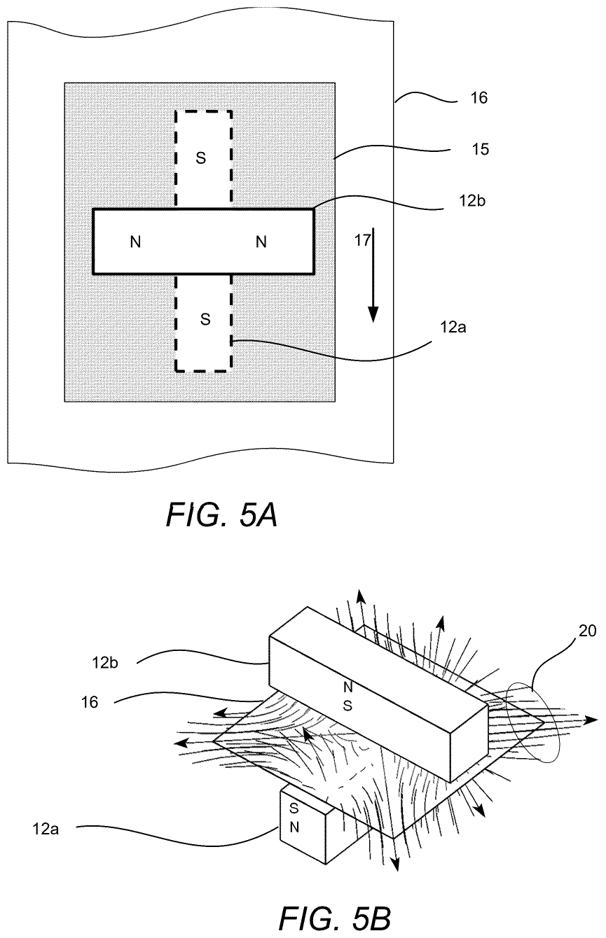

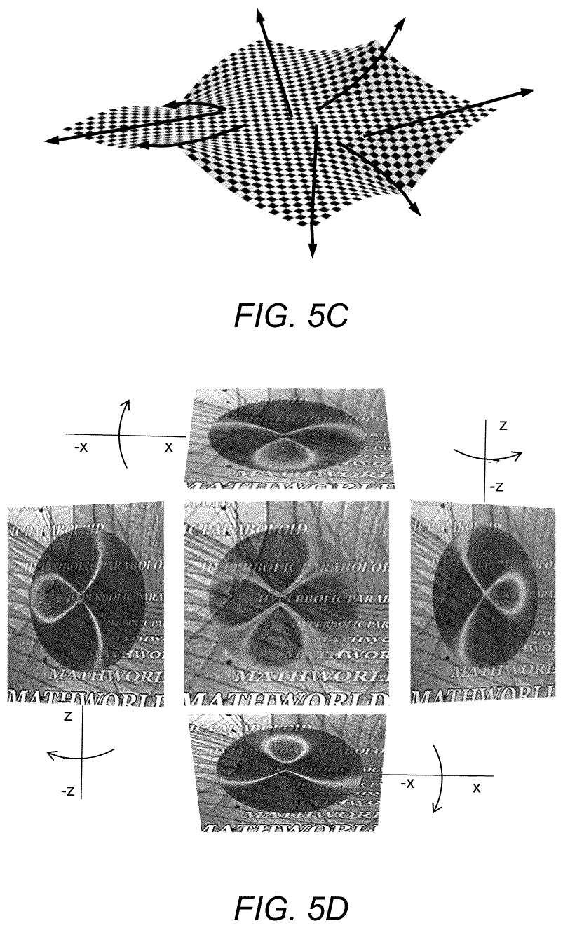

FIG. 5A illustrates a top view of simplified assembly. The planes of the magnets 12a, 12b were parallel to each other. The first magnet 12a was positioned below the substrate 16, which was coated with a composition 15 including magnetizable platelets. The second magnet 12b was positioned above the substrate 16. The first magnet 12a faced the second magnet 12b with their South poles. The substrate 16 was moved in the feed direction 17.

FIG. 5B illustrates the computer modeling of the magnetic field 20 produced by the first magnet 12a and the second magnet 12b. The magnetic field in a plane of the substrate 16 are squeezed away in all directions. The magnetizable platelets would align along the magnetic field 20 lines to produce a reflective surface, as shown in FIG. 5C. The assembly illustrated in FIG. 5A orients magnetizable platelets in the printed element producing the optical effect illustrated in FIG. 5D. The central image demonstrated the visual appearance of the print at a normal observation angle. All other images showed the visible appearance changed at their different rotations (tilts) around the horizontal and vertical axis.

### Example 2

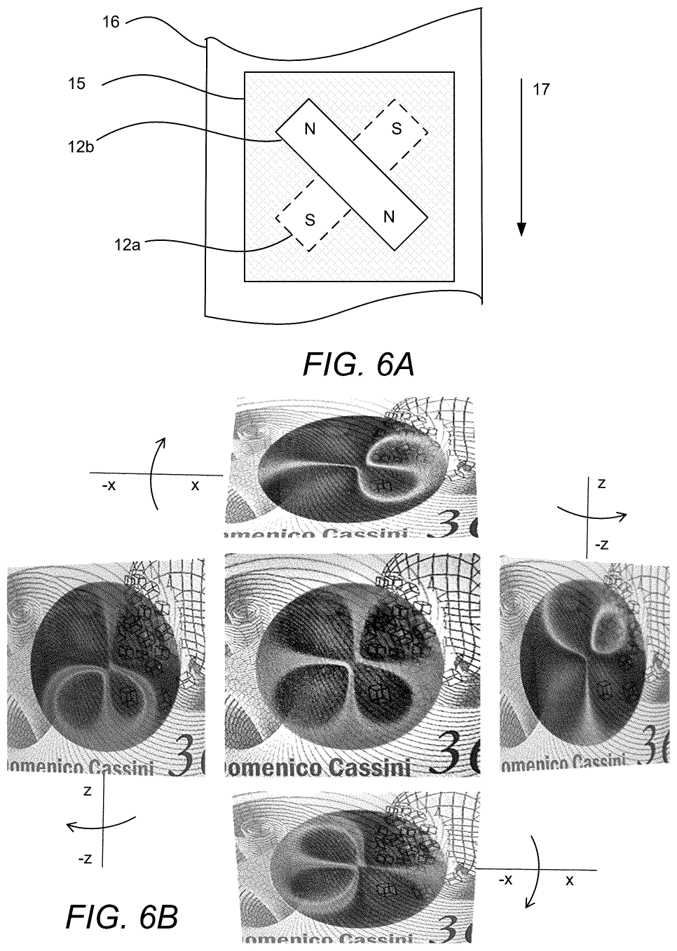

FIG. 6A illustrates the same assembly as shown in FIG. 5A is used, but the first magnet 12a and the second magnet 12b have been rotated 45° in the plane of the substrate 16. The assembly illustrated in FIG. 6A produced the images in FIG. 6B. The central image demonstrated the visual appearance of the print at a normal observation angle. All other images showed the visible appearance changed at their different rotations (tilts) around the horizontal and vertical axis. As can be seen, the images in FIG. 6B are substantially different from the images in FIG. 5D.

### Example 3

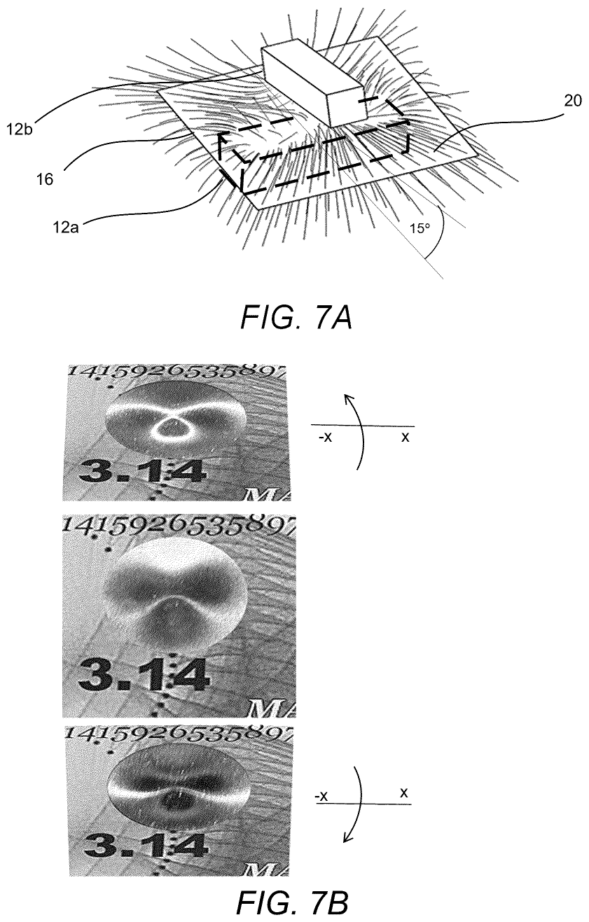

The assembly illustrated in FIG. 5A was used, but the planes of the first magnet 12a and the second magnet 12b were non-parallel. An angle of 15° was between the planes of the first magnet 12a and the second magnet 12b, as shown in FIG. 7A. An article was printed, as shown in FIG. 7B. The central image demonstrated the visual appearance of the print at a normal observation angle. All other images showed the visible appearance changed at their different rotations (tilts) around the horizontal and vertical axis.

### Example 4

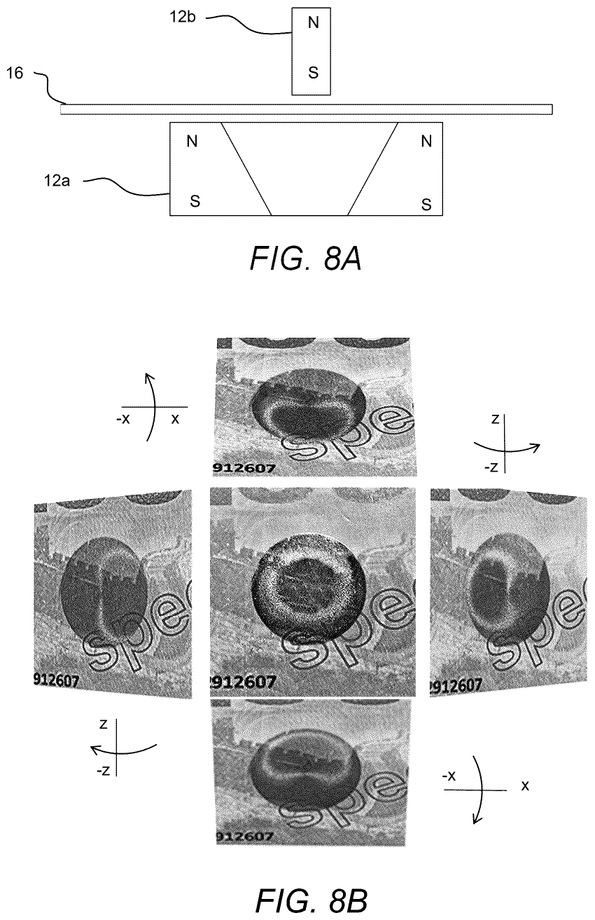

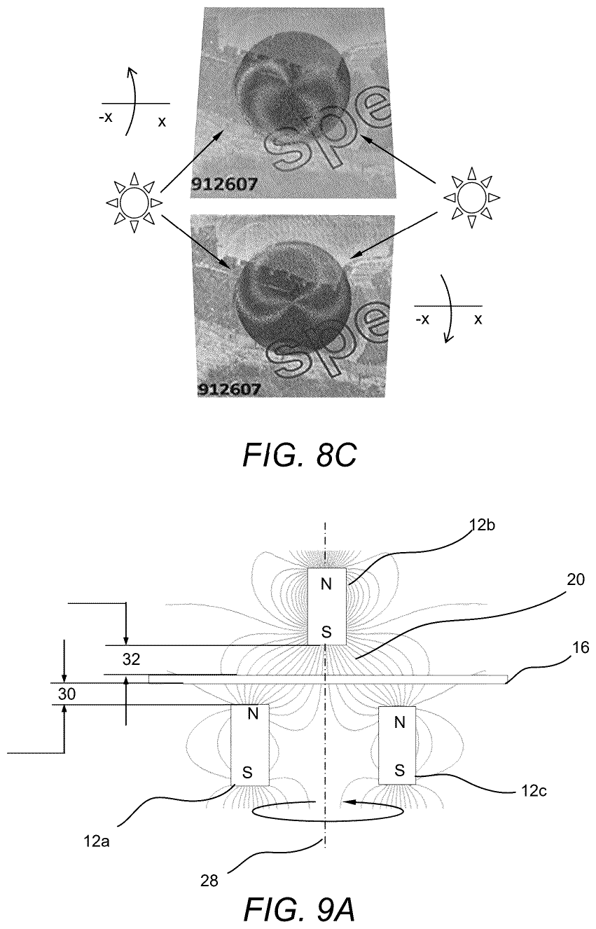

The assembly included a first magnet 12a, which is funnel-shaped, and is positioned under a substrate 16, and a second magnet 12b positioned over a substrate 16, as shown in FIG. 8A. Both the first magnet 12a and the second magnet 12b were mounted in a first cylinder 14a (not shown) and a second cylinder 14b (not shown), respectively. An article was printed, as shown in FIG. 8B. The central image demonstrated the visual appearance of the print at a normal observation angle. All other images showed the visible appearance changed at their different rotations (tilts) around the horizontal and vertical axis. In particular, a ring can be seen in the middle image that deforms at the different rotation angles of the substrate 16.

The article of FIG. 8B was illuminated by two different light sources to illustrate how the appearance of an element can change. Each light source produced its own deformed ring (not shown). The use of two different light sources at the same time, makes a “spider” pattern, as shown in FIG. 8C.

### Example 5

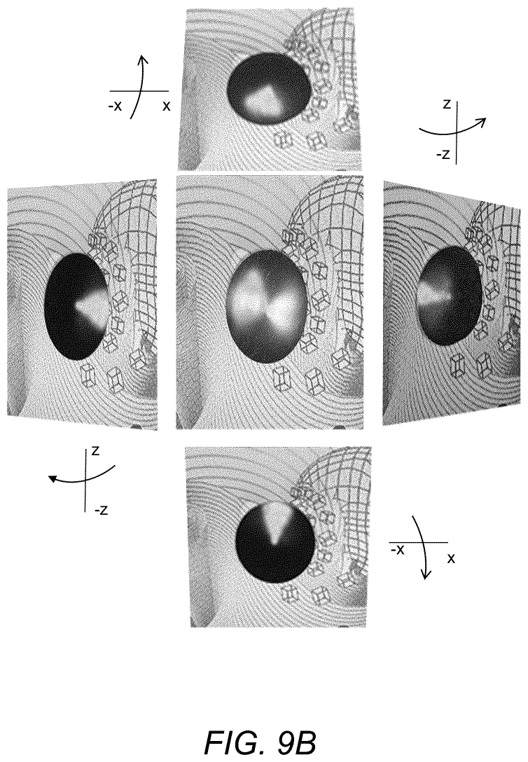

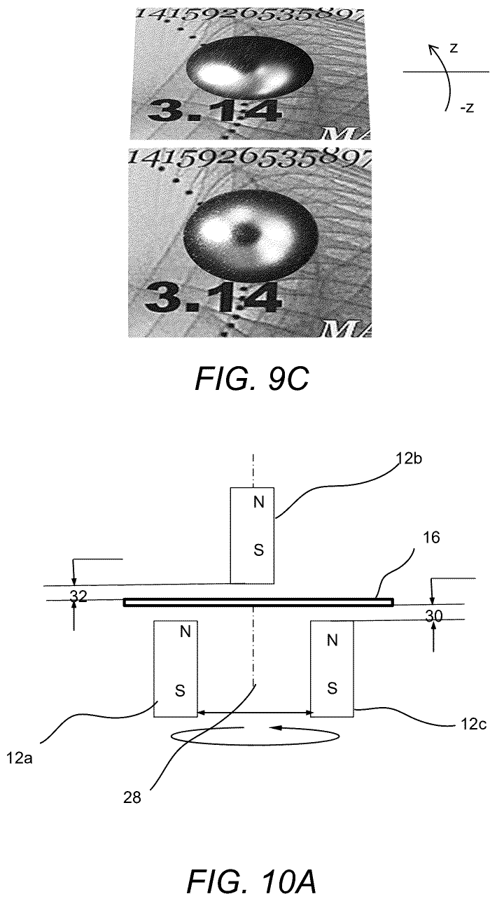

In another aspect, the assembly can include at least one magnet that can rotate around a central axis, and at least one magnet that is static. As shown in FIG. 9A, an assembly can include a first magnet 12a and a third magnet 12c with their north poles positioned a first distance 30, about 0.125 inch, to a substrate 16. The first magnet 12a is separated from the third magnet 12c by a gap of about 1 inch, and each can revolve around a central axis 28. A second magnet 12b was concentric to the central axis 28, and was statically mounted above the substrate 16 by a second distance 32, about 0.25 inch, with its south pole facing the rotating magnets 12a, 12c.

The assembly including the at least one rotating magnet and the at least one static magnet was used to produce an article. In particular, a substrate including a composition with a plurality of magnetizable platelets was subjected to a magnetic field 20, as shown in FIG. 9A. The aligned magnetizable platelets produced a Fresnel-like cone reflector, as shown in FIG. 9B. The central image demonstrated the visual appearance at a normal observation angle. All other images showed the visible appearance changed at their different rotations (tilts) around the horizontal and vertical axis.

The second distance 32 in FIG. 9A was reduced from about 0.25 inch to about 0.1 inch. As shown in FIG. 9C, the appearance of the image changed from a Fresnel-like cone to a crater.

### Example 6

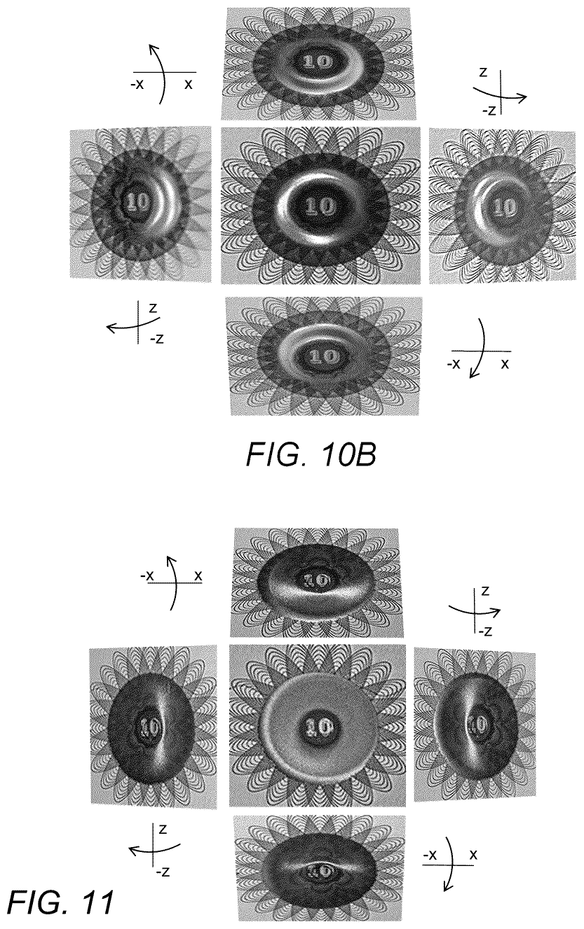

In another aspect, the assembly of FIG. 9A was used but the magnetic orientation of the second magnet 12b was changed. As shown in FIG. 10A, the second magnet 12b was turned so its north pole pointed toward the substrate 16 and the first magnet 12a and the third magnet 12c. The second distance 32 and the second distance were the same, i.e., about 0.07 inches. The repelling magnets 12b and 12a, 12c created a magnetic field (not shown). An article was printed, as shown in FIG. 10B, on a paper substrate 16 with a screen printing technique. The central image demonstrated the visual appearance of the print at a normal observation angle. All other images showed the visible appearance changed at their different rotations (tilts) around the horizontal and vertical axis. In particular, a ring can be seen in the middle image that deforms at the different rotation angles of the substrate 16. As can be seen, an illusion of depth is perceived, i.e., the numeral “10” in the center of the image looks to be about 0.25 inches below the ring's inner edge.

### Example 7

The assembly as shown in FIG. 9A was altered as follows: the first distance 30 and the second distance 32 were each reduced to 0.0625 inches; and the distance between the first magnet 12a and the third magnet 12c was increased from about 1 inch to about 1.63 inches. An article was printed, as shown in FIG. 11, on a paper substrate 16 with a screen printing technique. The central image demonstrated the visual appearance of the print at a normal observation angle. All other images showed the visible appearance changed at their different rotations (tilts) around the horizontal and vertical axis. In particular, the ring appeared flatter at a normal observation angle. Additionally, at all of the tilt angles, a wave appears instead of the ring.

### Example 8

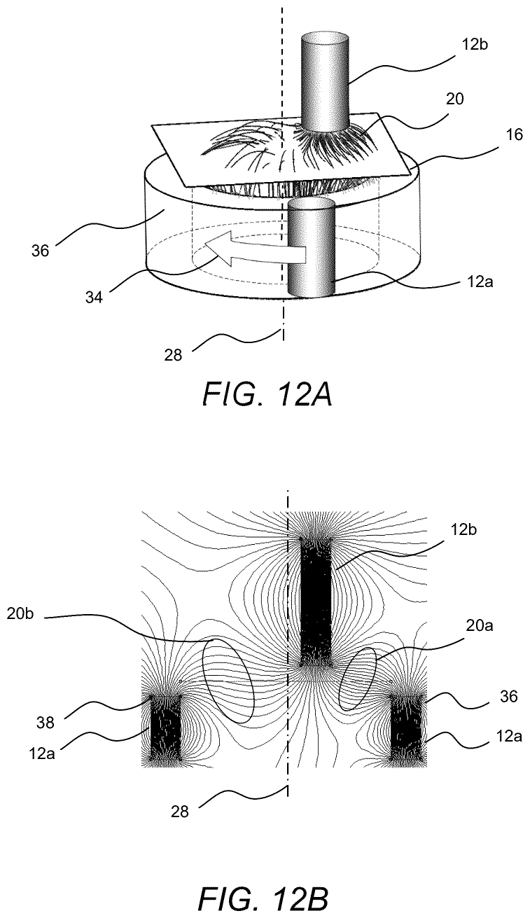

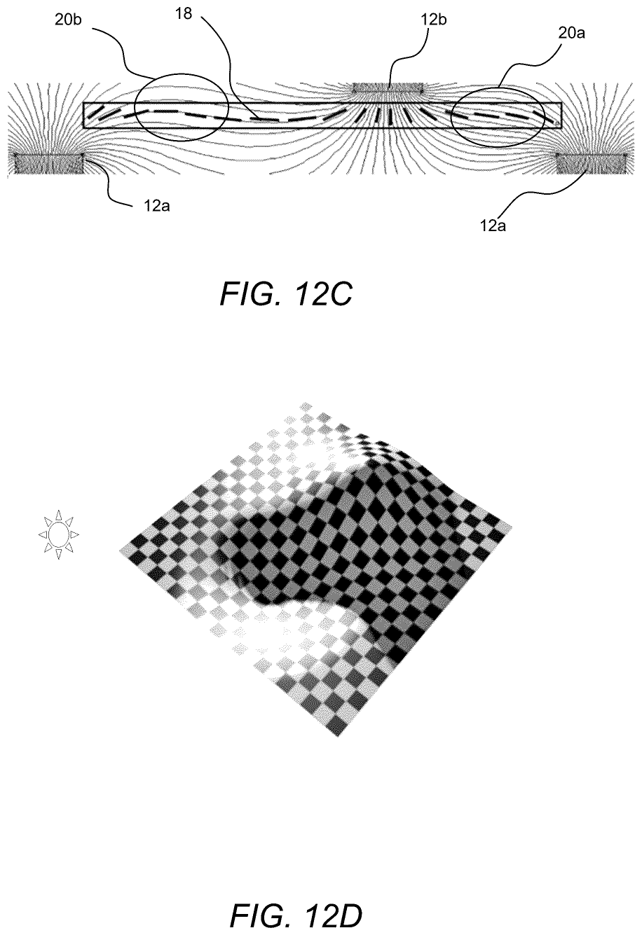

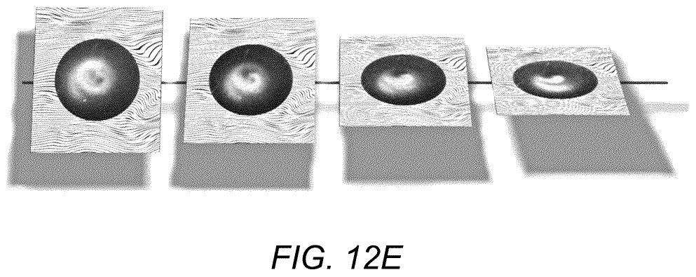

An advantage of the magnets, such as the first magnet 12a and the second magnet 12b installed in a first cylinder 14a (not shown) and a second cylinder 14b (not shown), respectively, is the opportunity of the asymmetric registrations of magnets when they come together with a substrate 16 in between. As shown in FIG. 12A, first magnet 12a rotated around central axis 28 in direction 34, forming trajectory 36 underneath the substrate 16. Second magnet 12b, statically mounted above substrate 16, generated asymmetric magnetic field 20, continually changing its configuration as first magnet 12a rotated.

FIG. 12B illustrates the asymmetry in the magnetic field generated by the first magnet 12a at two different locations 36 and 38 in the trajectory. The magnetic field in region 20a is generated by the first magnet 12a in location 36. The magnetic field in region 20b is generated by the first magnet 12a in location 38.

FIG. 12C illustrates a cross-section of a substrate 16 with a composition including magnetizable platelets 18 that are aligned in a magnetic field 20a, 20b generated by the assembly shown in FIGS. 12A-12B. The magnetizable platelets 18 aligned in the asymmetric magnetic field can generate a reflecting surface similar to the schematic surface in FIG. 12D with the light source positioned as shown.

FIG. 12E is an article made by printing a circle on a substrate 16 with a composition including magnetizable platelets in a magnetic field, as shown in FIGS. 12A-D. The article can exhibit a spiral-like bright shape on a dark background. The shape changed as the substrate 16 is tilted at the angles shown, relative to a normal observation angle.

From the foregoing description, those skilled in the art can appreciate that the present teachings can be implemented in a variety of forms. Therefore, while these teachings have been described in connection with particular embodiments and examples thereof, the true scope of the present teachings should not be so limited. Various changes and modifications can be made without departing from the scope of the teachings herein.

This scope disclosure is to be broadly construed. It is intended that this disclosure disclose equivalents, means, systems and methods to achieve the coatings, devices, activities and mechanical actions disclosed herein. For each coating, device, article, method, mean, mechanical element or mechanism disclosed, it is intended that this disclosure also encompass in its disclosure and teaches equivalents, means, systems and methods for practicing the many aspects, mechanisms and devices disclosed herein. Additionally, this disclosure regards a coating and its many aspects, features and elements. Such a coating can be dynamic in its use and operation, this disclosure is intended to encompass the equivalents, means, systems and methods of the use of the device and/or optical device of manufacture and its many aspects consistent with the description and spirit of the operations and functions disclosed herein. The claims of this application are likewise to be broadly construed. The description of the inventions herein in their many embodiments is merely exemplary in nature and, thus, variations that do not depart from the gist of the invention are intended to be within the scope of the invention. Such variations are not to be regarded as a departure from the spirit and scope of the invention.

1. An assembly, comprising:
a first magnet;
a substrate positioned above the first magnet, and having a surface for receiving a composition including a plurality of magnetizable platelets; and
a second magnet, positioned above the substrate.

2. The assembly of claim 1, wherein the first magnet is incorporated into a first cylinder, and the second magnet is incorporated into a second cylinder.

3-20. (canceled)

21. The assembly of claim 2, wherein the first magnet in the first cylinder is in register with the second magnet in the second cylinder.

22. The assembly of claim 21, wherein the first cylinder and the second cylinder rotate in a same or an opposite direction.

23. The assembly of claim 2, wherein the first magnet is a plurality of magnets embedded into the first cylinder.

24. The assembly of claim 23, wherein the second magnet is a plurality of magnets embedded into the second cylinder.

25. The assembly of claim 24, wherein the first magnet in the first cylinder is in register with the second magnet in the second cylinder.

26. The assembly of claim 1, further comprising a light source.

27. The assembly of claim 26, wherein the light source is a laser or a light emitting diode.

28. The assembly of claim 27, wherein the light emitting diode emits energy is a blue wavelength or an ultraviolet wavelength.

29. The assembly of claim 1, further comprising a third magnet aligned with the first magnet.

30. The assembly of claim 29, wherein the first magnet and the third magnet are cylinders.

31. The assembly of claim 29, wherein the first magnet and the third magnet are aligned in a z direction.

32. The assembly of claim 31, wherein a pole of the second magnet faces an opposite pole of the first magnet and the second magnet.

33. The assembly of claim 29, wherein the second magnet is statically positioned along a central axis; and wherein the first magnet and the third magnet revolve around the central axis.

34. The assembly of claim 29, wherein the first magnet is positioned a first distance from a surface of the substrate.
